(19) United States
(12) Patent Application Publication
(10) Pub. No.: US 2008/0154665 A1
(43) Pub. Date: Jun. 26, 2008

(54) Method for the Optimal Allocation of Operating Means

(76) Inventors: Katharina Seifert-Prenn, Wien (AT); Oliver Prenn, Wien (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/659,691

(22) PCT Filed: Aug. 9, 2005
(86) PCT No.: PCT/AT05/00323

§ 371 Date: Mar. 1, 2007

(30) Foreign Application Priority Data
Aug. 9, 2004 (AT) GM 577/2004

(51) Int. Cl. G06Q 10/00

(52) U.S. Cl. 705/7

(57) ABSTRACT

The invention relates to a method for the optimal allocation of operating means used for accomplishing predetermined tasks. Said method comprises the following steps:—a rule is selected from the rule database that allows the operating means to be evaluated efficiently;—a question is output that relates to a requirement of the task on which the selected rule is based;—a reply to said question is read in;—all operating means are evaluated regarding the requirement based on the selected rule by putting the technical data of each operating means in relation with the requiremcnt;—verification is made as to whether one or several operating means have been selected with sufficient accuracy, and if that is not the case, the first selection step is repeated and a new rule is selected;—the result of the selection is output if the selection is sufficiently accurate, and the process is terminated.

The invention relates to a method for the optimal allocation of operating means used for accomplishing predetermined tasks.

In all areas of technology there arises the recurring problem of selecting operating means or tools that are best suited to perform certain predetermined tasks. The problem may for instance pertain to machines used in a production process, where a diversity of machines may exist, however, all of which would be suitable for the task in principle, so that the optimum choice must be made. A similar situation arises when the machines are not yet available and have to be procured. The term product will in the following be used synonymously with operating means.

All operating means have certain technical specifications relevant for the performance of the task at hand, which are either known or may easily be found. The task at hand may in turn be subdivided into various requirements, where the categories of these requirements may partly coincide with certain of the specifications, but will differ in general.

A number of concepts are defined below, which will be used in the description of the invention.
A “rule” is based on utility functions and evaluates technical specifications in relation to a certain requirement;
“Utility” is the value of a product computed in the configuration process (or derived from a rule in the simplified method) relative to a certain requirement (unrestricted scale, for instance between 0 and 100);
The “total utility function” or “total utility value” is the sum total of the utilities of a product resulting from the evaluation of all rules after completion of the question-and-answer process. This value measures the suitability of the product in comparison with other products relative to the selected requirements. (Unsuitable products always have a total utility value of zero.);
A “question” is a block consisting of the question and answer options. Such blocks may comprise multiple-choice, single-choice or preference (more/less important) items;
A “requirement” relates to the utility for the user, is mapped onto an answering option and has a corresponding rule in the rule database.

A selection can be effected by formulating rules which will connect requirements with technical specifications. By applying these rules sequentially or simultaneously it is possible in principle to identify, on the basis of given requirements, technical specifications which the operating means must satisfy in order to meet all given requirements. Many users are unable to perform this kind of selection process based on specifications due to their lack of technical know-how. But in a large number of cases the application of such a selection process will also end with the result that operating means conforming to the technical specifications determined in the process are not available. The reason for this is the fact that the number of combinatorial possibilities which can theoretically be obtained from the requirements, is so vast that only a very small percentage of theoretically described operating means can be provided or procured in practice. Automation of such a selection method is difficult or rather impossible, since the probability of a non-practicable combination is far greater than that of a successful selection, and a user unassisted by expert help could attain a result only by an exceedingly lengthy trial and error process.

It is the object of the present invention to propose a method for selecting the best possible operating means, which can be automated to a high degree.

According to the invention the method comprises the following preparatory steps:
Definition of a set of operating means which are in principle capable of performing the given tasks;
Determination of the relevant technical data of each selected operating means and storage of the data in a database;
Definition of possible technical requirements which must be fulfilled by the operating means for use with the different tasks; if desired, these requirements may be assigned weights for the benefit of the user;
Formulation of a plurality of rules connecting the technical specifications of the operating means with the individual requirements, in order to determine the suitability of the operating means for performing the diverse tasks, and storage of these rules in a rule database; a relative value is defined for each requirement, which will indicate for each operating means, first, the degree to which it satisfies the requirement due to its technical specifications, and second, based on a ranking of the operating means and a resulting distribution computation, whether the individual operating means is more or less or equally suited, compared with others, to satisfy the requirements.

For a given, concrete selection the following steps are performed:
Selecting a rule from the rule database, which permits efficient evaluation of the operating means;
Outputting a question relating to a requirement of the task on which the selected rule is based, preferentially together with response alternatives or options;
Reading in the answer to the question posed;
Evaluating all operating means in relation to the requirement using the selected rule, by relating each operating means to the requirement as regards technical specifications and its relative suitability in comparison with others; certain operating means will be eliminated from the further selection process, if they have been found to be “not suitable”;
Analysing all operating means still present in the selection process to establish which combination of requirements according to the rule database is still possible in view of the given combination of technical specifications. The result of this analysis will be used in the presentation of further questions. Questions pertaining to products which cannot occur or do not exist in the given combination are thereby eliminated;
Checking whether one or more operating means have been selected with sufficient accuracy. If this is not the case and if the rule used provides for it, further answers may be read in (“multiple choice”) or the process may loop back to the first selection step and the next rule may be chosen;
If a selection has been effected with sufficient accuracy the result is output and the process ends.

In a preferred variant of the invention it is provided that the rules are based on utility functions, which quantify the contribution of an individual technical specification to the fulfilment of a given requirement and that the utility functions related to the diverse requirements are combined by multiplication to obtain the total utility function relative to the given task.

An essential point of the present invention is the fact that the know-how of highly qualified experts is needed only in the preparatory steps for the definition of the rules database. Since the expert knowledge is stored in the database, rules and new products may be added or existing rules may be updated without great effort. After the preparatory steps have been performed the method may be used in a multitude of different cases without the need to consult experts. The advantage of the method for the user lies in the relatively small number of questions/answers required for the—actually very complex—selection process, making it very simple while still producing accurate results. The method of the invention may be applied for internal planning and production processes, but also in a sales context, where the rules are provided by the vendor and the method is applied by the purchaser who does not have expert help available. Combining the individual utility functions multiplicatively to obtain a total utility function is an essential aspect of the invention. If a requirement cannot be met, the respective utility function will have the value zero. As a consequence, the respective operating means will have a utility of zero, independently of its score for other requirements. A particular advantage of the multiplicative combination is the unique indication of an unsuitable operating means by its utility function having the value 0. The invention differs in this respect from systems in which a large negative weight indicates the non-fulfilment of a certain requirement, thus permitting a ranking of operating means to be constructed in which all elements do not fulfil one or the other essential requirement. Due to the multiplicative combination an essential characteristic of the system of the invention is realized, i.e. that no questions are output which do not make sense or do not contribute to finding a decision or have as a consequence that no eligible alternatives remain.

It is an essential attribute of the invention that not only questions as such will be judged by their constructive contribution to the decision process, but that also alternative answers which do not make sense or are not permissible, will be eliminated.

Questions consist of question-blocks: the question proper and possible answers. The answers may be of the multiple-choice, single-choice or preference (more important/less important) type. Whole question-blocks or individual answering options are eliminated if it can be inferred from the preceding questioning process that they will no longer contribute to finding a result.

If, for example, in the selection of a power drill it is found in the preceding questioning process that a certain minimum drilling power will be necessary due to expected requirements, all alternatives relating to drilling machines with drilling power less than the established minimum will be eliminated in the course of subsequent questions.

Configuration, i.e. performance of the preparatory steps, is substantially simplified by the fact that the rules are based on utility functions, which quantify the contribution of individual technical data to the fulfilling of given requirements. In particular, this will make it easy to take into account changes in the available operating means or to extend the selection process to newly available operating means.

Configuration is assisted in particular, if the “utility values” resulting from the utility functions may assume arbitrary values between a maximum and a minimum. In this way a particularly transparent presentation of the method's basic model is achieved.

In certain cases some of the rules may already be evaluated during the preparatory steps, i.e. the suitability of individual operating means for fulfilling predetermined tasks may be ascertained a priori, and during the selection process this knowledge base may be utilised.

The invention will now be described in more detail referring to the examples shown in the enclosed drawings.

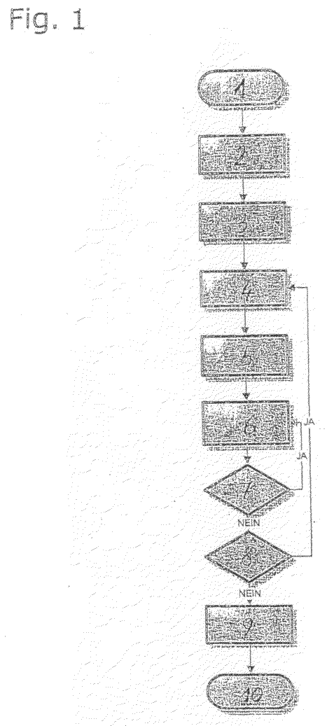

FIG. 1 is a flow chart explaining the configuration of the system, and

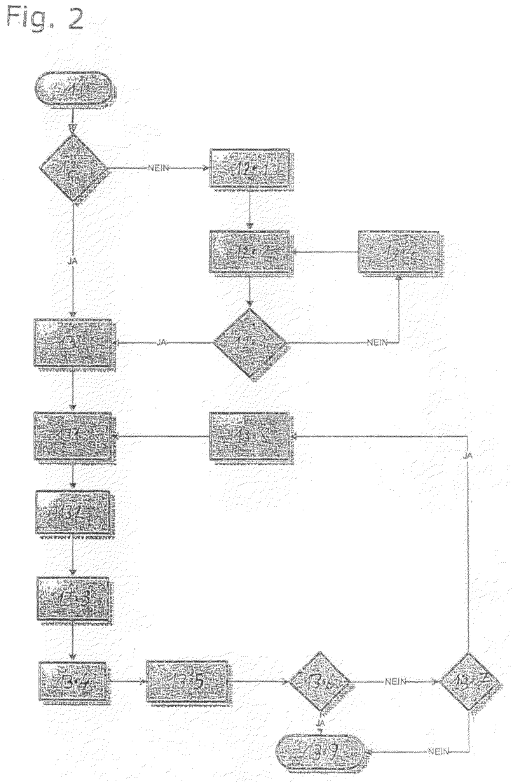

FIG. 2 is a flow chart explaining the steps of the selection process proper.

Configuration, i.e. performance of the preparatory steps, is carried out in detail as follows.

Step 1 is the start of the configuration program. In step 2 product groups are defined, which are to be presented in the selection process. In step 3 a person with special knowledge, i.e. an expert, defines relevant questions, which permit distinguishing the products using a minimal number of questions. For each possible answer a basic rule is defined, which states the attributes, i.e. technical specifications, a product must have to be evaluated positively. In step 4 a question is selected and weighted. In step 5 a product which is to be evaluated as an operating means, is selected, it being advisable to start with the best or the worst product. In step 6 another product is selected and evaluated relatively to the one selected in step 5. The evaluation can be presented as a utility function. Step 7 checks if there are any more products left for evaluation, in which case the program loops back to step 6. Step 8 checks if there are any more questions, in the “yes”-case the program loops back to step 4, in the “no”-case the configuration is stored in step 9 and the program ends with step 10.

It should be noted that the procedure described above is simplified in so far as the rules mentioned above in themselves constitute the evaluation of the product. Such an approach will be indicated if the number of products is relatively small. If a multitude of products is available as operating means the procedure is modified by defining a rule in step 5, which determines how the utility for performing a certain task may be derived from the technical specifications of all products. This rule is then applied in step 6 to the available products in order to evaluate them.

The flow chart of FIG. 2 describes the selection process proper for a certain product or operating means. The program starts with step 11. Step 12 asks the user whether he knows the desired product category; if he does not, step 12.1 presents help information for the selection of a product group. In step 12.2 a question characteristic is selected which corresponds to the desired product. Step 12.3 checks if the product group is now uniquely determined; if not, step 12.4 is executed, selecting a new group of questions, whereupon the program proceeds to step 12.2.

If it is established in step 12 that the user knows the product group desired, step 13 starts the question group relevant for the product category. In step 13.1 the user selects requirements from among answer-options presented. In step 13.2 the system checks if all sub-questions are possible in the case of multiple selections, to this end the remaining possible questions for the question-group are determined based on the answers chosen. If a chosen combination has only zeros in a further question, the additional question has no valid answer and is therefore deactivated. Thus an invalid selection within a question group is avoided. The variables influencing this decision are the weight of the question-group and the relative utility value of the question within the catalogue of questions.

In step 13.3 the system computes the relative utility value using the expert-defined rules for the product and the possible answer. In step 13.4 an internal ranking of the products or operating means based on the present and previous selection steps is constructed. The internal ranking is computed from present and previous selections and each product is assigned a total utility value. In step 13.5 invalid results are eliminated from the list. Products which fail completely to meet the requirements (i.e. for which the utility function becomes zero after a certain step) are discarded. In step 13.6 it is tested if the current number of results in the list is less than the maximum admissible number of products in the list of results. If this is the case the program ends in step 13.9; if not, step 13.7 tests for the presence of further question-groups. If no further question-groups are found the program also ends in step 13.9, otherwise the program loops back to step 13.8, where the next question-group is started, and the program then branches to step 13.1.

The method of the invention will now be explained in more detail using a simplified example. The set of operating means consists of five different products, all of them power drills. The tasks to be performed are drilling, screwing and mixing (of paints, cements, etc.).

Database

The matrix describing the power drill products could be as follows:

| Weight = 60 | Products: Power drills | | | | |
|---|---|---|---|---|---|
| What do you want to do? | S | M | B20 | B30 | B10 |
| Screw | 100 | 0 | 1 | 0 | 50 |
| Drill | 80 | 50 | 100 | 100 | 100 |
| Mix | 0 | 100 | 0 | 10 | 0 |

All power drills are capable of drilling, but only “S” and “B10” and “B20” can be used for screwing. Mixing can only be done with “B30” and the mixer/drill “M”.

Selection of an Attribute

If this matrix were presented with a simple question all products would be presented for selection.

What do you want to do with the power drill?
Type of use

□ screw [symbol]
drill
□ mix

Fig.: First step selection of attribute “drill”

After each selection the testing algorithm in the background identifies possible combinations and invalid solutions are no longer displayed, as can be seen in the following example. In the above example a device capable of screwing cannot mix and a device capable of mixing cannot screw.

What do you want to do with the power drill?
Type of use

[symbol]

screw [symbol]
drill
□ mix

Fig.: If “drill” and “screw” is selected “mix” is deactivated.

TABLE
Data for the example “selection of drill and screw”.

| Weight = 60 | Products: Power drills | | | | |
|---|---|---|---|---|---|
| What do you want to do? | S | M | B20 | B30 | B10 |
| Screw | 100 | 0 | 1 | 0 | 50 |
| Drill | 80 | 50 | 100 | 100 | 100 |
| Mix | 0 | 100 | 0 | 10 | 0 |

Valid combinations are coloured grey. “Mix” has no positive utility for this combination and is therefore not presented for selection.

What do you want to do with the power drill?
Type of use

□ screw [symbol]
drill [symbol]
mix

Fig.: If “drill” and “mix” is selected “screw” is deactivated.

TABLE
Data for example “Selection of drill and mix”.

| Weight = 60 | Products: Power drills | | | | |
|---|---|---|---|---|---|
| What do you want to do? | S | M | B20 | B30 | B10 |
| Screw | 100 | 0 | 1 | 0 | 50 |
| Drill | 80 | 50 | 100 | 100 | 100 |
| Mix | 0 | 100 | 0 | 10 | 0 |

Valid combinations are coloured grey. “Screw” has no positive utility for this combination and is therefore not presented for selection.

This is achieved by checking for each question-group in the matrix if the combination contains only zeros for a question of detail; if so, the question is deactivated.

Computation of the Ranking by Utility Values

The products are ranked by their utility value. In this process not only product attributes, which have no additional utility, are deleted from the question list, but the products themselves are excluded from further computation during the processing of the question, i.e. only valid combinations are kept for further processing. In the case of many products and many questions this speeds up the questioning process.

Computation in general uses the following equation:

Utility value of a question-group=weight of the question-group * (sum of the question-group/number of selected questions)/100

Invalid combinations are excluded. Division by 100 is performed to avoid large numbers. The individual questions within a question-group have equal weight, therefore division by the number of questions is performed.

### Example

Choosing a Mixer

The product matrix could be as follows:

| Weight = 60 | Products: Power drills | | | | |
|---|---|---|---|---|---|
| What do you want to do? | S | M | B20 | B30 | B10 |
| Screw | 100 | 0 | 1 | 0 | 50 |
| Drill | 80 | 50 | 100 | 100 | 100 |
| Mix | 0 | 100 | 0 | 10 | 0 |

All power drills are capable of drilling, but only “S” and “B10” and “B20” can be used for screwing. Mixing can only be done with “B30” and the mixer/drill “M”.

A second matrix defines the chuck sizes that can be used with the devices.

| Weight = 40 | Products: Power drills | | | | |
|---|---|---|---|---|---|
| Choose the chuck size | S | M | B20 | B30 | B10 |
| <10 mm | 100 | 0 | 50 | 10 | 100 |
| <20 mm | 0 | 0 | 100 | 30 | 0 |
| <30 mm | 0 | 100 | 0 | 100 | 0 |

Start of the selection process:

Question group 1 “What do you want to do with the power drill?”

What do you want to do with the power drill?
Type of use

□ screw [symbol]
drill [symbol]
mix

Fig.: “drill” and “mix” are selected.

TABLE
Data for the attributes of the power drill.

| Weight = 60 | Products: Power drills | | | | |
|---|---|---|---|---|---|
| What do you want to do? | S | M | B20 | B30 | B10 |
| Screw | 100 | 0 | 1 | 0 | 50 |
| Drill | 80 | 50 | 100 | 100 | 100 |
| Mix | 0 | 100 | 0 | 10 | 0 |

Computation of the valid values

Product M=45=60((50+100)/2)/100

Product B20=33=60((10+100)/2)/100

Matched Product

M −45 Tune □B30 [symbol] 33 Tune □

List: Ranking of the products by utility value

Invalid combinations

S, B20, B10 are discarded on account of 0 for “mix”.

For the second question group the following matrix is given.

TABLE
Data showing possible chuck-sizes of the power drills.

| Weight = 40 | Products: Power Drills | | | | |
|---|---|---|---|---|---|
| Choose the chuck size | S | M | B20 | B30 | B10 |
| <10 mm | 100 | 0 | 50 | 10 | 100 |
| <20 mm | 0 | 0 | 100 | 30 | 0 |
| <30 mm | 0 | 100 | 0 | 100 | 0 |

Selection of “up to 10 mm” has only one valid solution: B30

Selection of “up to 20 mm” has only one valid solution: B30

Selection of “up to 30 mm” has two valid solutions: B30 and M.

The total utility value is computed as follows:

M=85=45+40*(100/1)/100

B30=73=33+40*(100/1)/100

### Matched Product

M −85 Tune □

B30 −73 Tune □

List: Ranking of the products by utility value.

The product “M” would be the most suitable, having a total utility of 85, followed by B30.

### Second Example

Drilling Only

Only “drill” is selected.

What do you want to do with the power drill?
Type of use

□ screw [symbol]
drill
□ mix

Fig.: “drill” selected

All power drills are eligible.

The utility values of the individual devices are:

Matched P

B10 −60

B20 [symbol] 60

B30 [symbol] 60

M [symbol] 30

S [symbol] 6

List: ranking of the products by utility value

The specialized power drills B10, B20, B30 have the advantage.

Second question group

Choose the chuck size

Chuck size

◯<10 mm

◯<20 mm

⊙<30 mm

Fig.: Question “chuck size”

For “Up to 30 mm” the two products B30 and M are again the only possible candidates. Now B30, being a specialized power drill, takes first place, while M comes second.

Total Result

B30 ̂100

M ̂70

List: Ranking of the products by utility value after the second question.

Alternative selection of a 10 mm chuck:

If a small 10 mm chuck had been selected, the following ranking would have resulted:

Choose the Chuck Size

Chuck Size

⊙<10 mm

◯<20 mm

◯<30 mm

Fig.: Selection of chuck size 10 mm

Result

B10 −100

S ̂88

B20 −80

B30 [symbol] 64

List: ranking of the products by utility value for a 10 mm chuck in combination with the first question

The computed ranking would be: B10 followed by S, preceding the power drills B20 and B30.

1. Method for the optimal allocation of operating means used for accomplishing predetermined tasks, comprising the following preparatoy steps:
defining a set of operating means which are in principle capable of performing the given tasks;
determining the relevant technical data of each selected operating means and storage of the data in a database;
defining possible technical requirements which the operating means to be used for the different tasks must fulfill;
formulating a plurality of rules combining the technical specifications of the operating means with the individual requirements, in order to determine the suitability of the operating means for performing the diverse tasks, and storing of these rules in a rule database;
where for a concrete selection of an operating means for a predetermined task the following steps are performed:
selecting a rule from the rule database, which permits efficient evaluation of the operating means;
outputting a question related to a requirement of the task on which the selected rule is based, preferentially together with response alternatives;
reading in the answer to the question posed;
evaluating all operating means in relation to the requirement by means of the selected rule, by relating the technical data of each operating means to the requirement;
checking whether one or more operating means have been selected with sufficient accuracy, and if this is not the case, checking which further rules should be queried based on the answers already received;
looping back to the first selection step and selecting the next rule which makes sense according to the preceding step; and
if a selection is sufficiently accurate, the result is output and the process is terminated.

2. Method according to claim 1, wherein the step of selecting a rule from the rule database comprises the selection of a question related to the rule, and the selection process includes checking whether at least one operating means is present for each possible response alternative, which satisfies all requirements including those which are presented by the possible answer to the question.

3. Method according to claim 2, in wherein for questions with more than two response alternatives, those alternatives are eliminated whose selection would lead to invalid results.

4. Method according to claim 1, wherein the rules are based on utility functions, which quantify the contribution of the individual technical data to the fulfilling of the given requirements.

5. Method according to claim 4, wherein the utility functions may take arbitrary values between a minimum and a maximum.

6. Method according to claim 5, wherein the utility functions corresponding to individual requirements are combined into a total utility function corresponding to the given task.

7. Method according to claim 6, wherein the combining of the utility functions into a total utility function is carried out by multiplication.

8. Method according to claim 6, wherein the combining of the utility functions into a total utility function is carried out by addition.

9. Method according to claim 1, wherein the results of the selection process are output in the computed rank sequence of suitability of the products.
